(19) United States
(12) Patent Application Publication
(10) Pub. No.: US 2011/0296812 A1
(43) Pub. Date: Dec. 8, 2011

(54) THRUST REVERSER ACTUATION SYSTEM ARCHITECTURE

(75) Inventors: Steve Abel, Chandler, AZ (US); Tony Libera, Tempe, AZ (US)

(73) Assignee: HONEYWELL INTERNATIONAL INC., Morristown, NJ (US)

(21) Appl. No.: 12/796,418

(22) Filed: Jun. 8, 2010

(51) Int. Cl. F02K 1/54; H02K 7/116; H02K 7/102; F16H 57/00

(52) U.S. Cl. 60/226.2; 74/640; 310/83; 310/77

(57) ABSTRACT

A thrust reverser actuation system includes a plurality of actuators, a power drive unit, and a gear set. Each actuator is coupled to receive an actuator input torque and is configured, upon receipt of the actuator input torque, to move between a stowed position and a deployed position. The power drive unit has only one output shaft, and is configured to supply a drive torque via the output shaft. The gear set is connected to the output shaft and is coupled to each of the actuators. The gear set is configured to receive the drive torque via the output shaft and to supply the actuator input torque to each of the actuators.

### TECHNICAL FIELD

The present invention generally relates to aircraft engine thrust reverser actuation systems and, more particularly, to a relatively simplified thrust reverser actuation system architecture.

### BACKGROUND

When a jet-powered aircraft lands, the landing gear brakes and aerodynamic drag (e.g., flaps, spoilers, etc.) of the aircraft may not, in certain situations, be sufficient to slow the aircraft down in the required amount of runway distance. Thus, jet engines on most commercial aircraft include thrust reversers to enhance the braking of the aircraft. When deployed, a thrust reverser redirects the rearward thrust of the jet engine to a generally or partially forward direction to decelerate the aircraft. Because at least some of the jet thrust is directed forward, the jet thrust also slows down the aircraft upon landing.

Various thrust reverser designs are commonly known, and the particular design utilized depends, at least in part, on the engine manufacturer, the engine configuration, and the propulsion technology being used. Thrust reverser designs used most prominently with jet engines fall into three general categories: (1) cascade-type thrust reversers; (2) target-type thrust reversers; and (3) pivot door thrust reversers. Each of these designs employs a different type of moveable thrust reverser component to change the direction of the jet thrust.

The moveable thrust reverser components in each of the above-described designs are moved between the stowed and deployed positions by actuators. Power to drive the actuators may come from a dual output power drive unit (PDU), which may be electrically, hydraulically, or pneumatically operated, depending on the system design. A drive train that includes one or more drive mechanisms, such as flexible rotating shafts, may interconnect the actuators and the PDU to transmit the PDU's drive force to the moveable thrust reverser components.

Each of the above-described thrust reverser system configurations is robustly designed and is safe and reliable. Nonetheless, the configurations include numerous components and, as a result, can be relatively heavy, costly, and complex. Hence, there is a need for a thrust reverser actuation system that is relatively light, inexpensive, and less complex than presently known systems. The present invention addresses at least this need.

### BRIEF SUMMARY

In one embodiment, a thrust reverser actuation system includes a plurality of actuators, a power drive unit, and a gear set. Each actuator is coupled to receive an actuator input torque and is configured, upon receipt of the actuator input torque, to move between a stowed position and a deployed position. The power drive unit has only one output shaft, and is configured to supply a drive torque via the output shaft. The gear set is connected to the output shaft and is coupled to each of the actuators. The gear set is configured to receive the drive torque via the output shaft and to supply the actuator input torque to each of the actuators.

In another embodiment, a thrust reverser actuation system includes a plurality of actuators, an electric motor, and a right angle, speed-reducing gear set. Each actuator is coupled to receive an actuator input torque and is configured, upon receipt of the actuator input torque, to move between a stowed position and a deployed position. The electric motor has only one output shaft, and is adapted to be selectively energized and is configured, upon being energized, to supply a motor drive torque via the output shaft. The gear set has a gear set input shaft, a first gear set output shaft, and a second gear set output shaft. The gear set input shaft is connected to the motor output shaft to receive the motor drive torque. The first gear set output shaft and the second gear set output shaft are each coupled to at least two of the actuators to supply the actuator input torque thereto.

In yet a further embodiment, a thrust reverser actuation system includes a first moveable thrust reverser component, a second movable thrust reverser component, a plurality of first actuators, a plurality of second actuators, an electric motor, and a gear set. The first and second moveable thrust reverser components are configured to move between a stowed position and a deployed position. Each first actuator is coupled the first moveable thrust reverser component, and each second actuator is coupled to the second movable thrust reverser component. Each first actuator is further coupled to receive an actuator input torque and is configured, upon receipt of the actuator input torque, to move between a stowed position and a deployed position, to thereby move the first moveable thrust reverser component between its stowed position and deployed position, respectively. Each second actuator is further coupled to receive an actuator input torque and is configured, upon receipt of the actuator input torque, to move between a stowed position and a deployed position, to thereby move the second moveable thrust reverser component between its stowed position and deployed position, respectively. The electric motor has only one output shaft, is adapted to be selectively energized, and is configured, upon being energized, to supply a motor drive torque via the output shaft. The gear set is connected to the output shaft and is coupled to each of the first actuators and to each of the second actuators. The gear set is configured to receive the drive torque via the output shaft and supply the actuator input torque to the first actuators and the second actuators.

Furthermore, other desirable features and characteristics of the thrust reverser actuation system will become apparent from the subsequent detailed description and the appended claims, taken in conjunction with the accompanying drawings and preceding background.

### BRIEF DESCRIPTION OF THE DRAWINGS

The present invention will hereinafter be described in conjunction with the following drawing figures, wherein like numerals denote like elements, and

FIG. 1 depicts a perspective view of portions of an aircraft engine fan case;

FIG. 2 depicts a functional schematic diagram of an embodiment of thrust reverser actuation system in which, for illustrative purposes, the motor shown rotated out of its engine-aligned axis; and

FIG. 3 depicts a simplified cross section view of an exemplary angled gear set that may be used in the system of FIG. 2.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description. Thus, although the description is explicitly directed toward an embodiment that is implemented in a cascade-type thrust reverser system, in which transcowls are used as the moveable thrust reverser component, it should be appreciated that it can be implemented in other thrust reverser actuation system designs, including those described above and those known now or hereafter in the art.

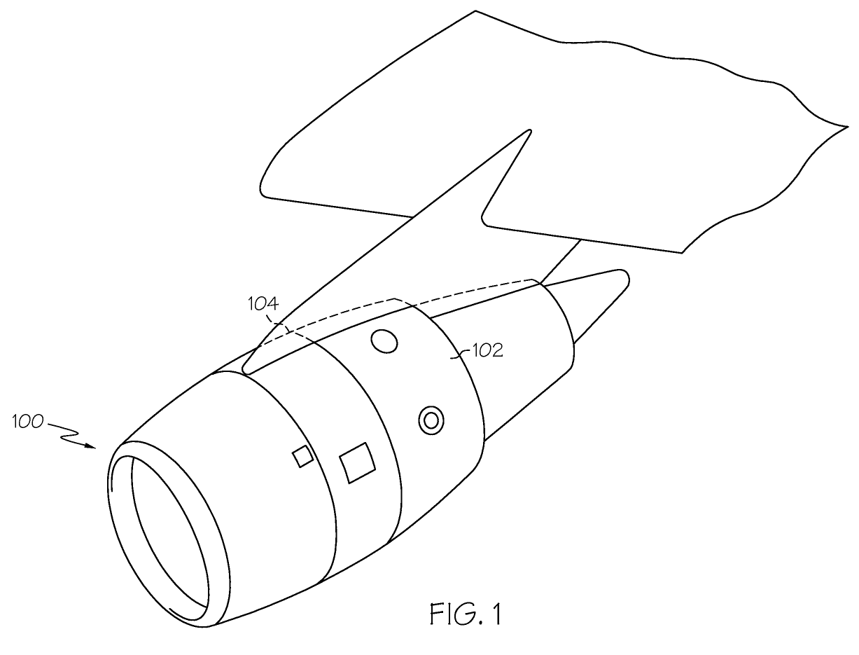

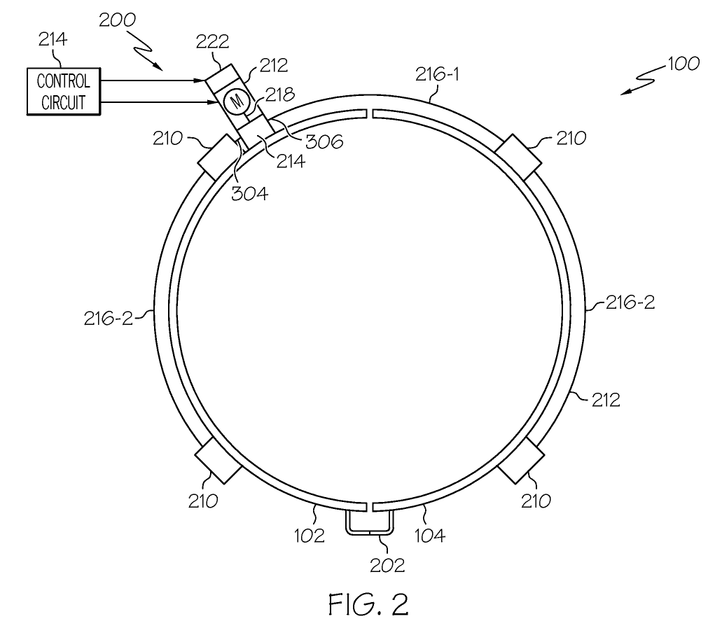

Turning now to the description, and with reference first to FIG. 1, a perspective view of portions of an aircraft jet engine fan case 100 that incorporates a cascade-type thrust reverser is depicted. The engine fan case 100 includes a pair of semi-circular transcowls 102 and 104 that are positioned circumferentially on the outside of the fan case 100. The transcowls 102 and 104 cover a plurality of non-illustrated cascade vanes. A mechanical link 202 (see FIG. 2), such as a pin or latch, may couple the transcowls 102 and 104 together to maintain the transcowls 102 and 104 in correct alignment on non-illustrated guides on which the transcowls 102 and 104 translate. When the thrust reversers are commanded to deploy, the transcowls 102 and 104 are translated aft. This, among other things, exposes the cascade vanes, and causes at least a portion of the air flowing through the engine fan case 100 to be redirected, at least partially, in a forward direction. This re-direction of air flow in a forward direction creates a reverse thrust, and thus works to slow the airplane.

The transcowls 102 and 104 are moved between the deploy and stow positions via a thrust reverser actuation system. An exemplary embodiment of a thrust reverser actuation system 200 is depicted in FIG. 2, and includes a plurality of actuators 210, a power drive unit 212, a gear set 214, and a plurality of drive mechanisms 216. The actuators 210 are individually coupled to the transcowls 102 and 104. The actuators 210 are additionally coupled to receive an actuator input torque and are configured, upon receipt of the actuator input torque, to move between a stowed position and a deployed position, to thereby move the transcowls 102 and 104 between the deploy and stow positions, respectively. In the depicted embodiment, half of the actuators 210 (which may be referred to herein as first actuators) are coupled to one of the transcowls 102, and the other half (which may be referred to herein as second actuators) are coupled to the other transcowl 104. It is noted that the actuators 210 may be any one of numerous actuator designs presently known in the art or hereafter designed. However, in this embodiment the actuators 210 are ballscrew actuators. It is additionally noted that the number and arrangement of actuators 210 is not limited to what is depicted in FIG. 2, but could include other numbers of actuators 210 as well. The number and arrangement of actuators 210 is selected to meet the specific design requirements of the system.

The power drive unit (PDU) 212 has only one output shaft 218, and is configured to selectively supply a drive torque via the output shaft 218. In the depicted embodiment, the PDU 212 is implemented as a motor, which may be any one of numerous types of motors such as, for example, an electric (including any one of the various DC or AC motor designs known in the art), a hydraulic, or a pneumatic motor. Preferably, however, the motor 212 is an electric motor that is adapted to be selectively energized and is configured, upon being energized, to supply the drive torque via the output shaft.

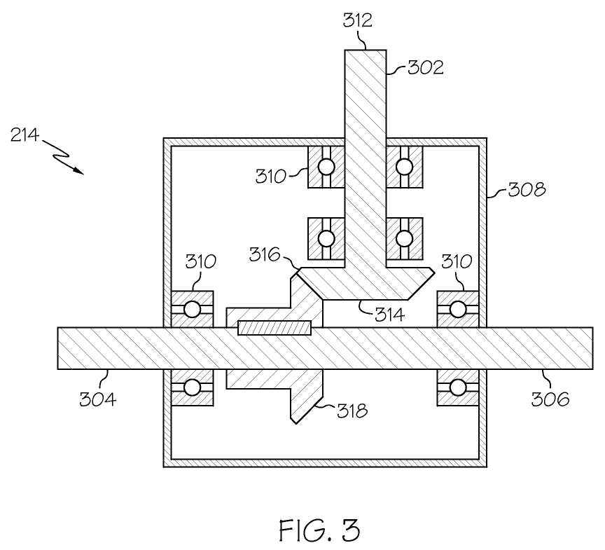

The gear set 214 is connected to the output shaft 218 and is coupled to each of the actuators 210. The gear set thus receives the drive torque supplied from the PDU 212, via the output shaft 218, and supplies the actuator input torque to each of the actuators 210. Although its configuration may vary, in the depicted embodiment the gear set 214 is implemented using a dual output, right angle, speed-reducing gear set. A cross section view of one particular embodiment of such a gear set 214 is depicted in FIG. 3 and, for completeness, will now be described.

The depicted gear set 214 includes a gear set input shaft 302, a first gear set output shaft 304, and a second gear set output shaft 306, all rotationally mounted within a housing 308 via a plurality of bearings 310. The gear set input shaft 302 has a first end 312 and a second end 314. When the gear set 214 is installed in the thrust reverser actuation system 200, the first end 312 of the gear set input shat 302 is connected to the output shaft 218 of the PDU 212, and thus receives the motor drive torque. The second end 314 of the gear set input shaft 302 has an angled input gear 316 formed thereon that meshes with an angled output gear 318, which is coupled to both the first and second gear set output shafts 304 and 306. The angled input gear 316 and the angled output gear 318 are configured such that, together, suitable speed reduction is provided between the gear set input shaft 302 and the first and second gear set output shafts 304 and 306. In the depicted embodiment, the first and second gear set output shafts 304 and 306 are integrally formed as single component. It will be appreciated that in other embodiments the first and second gear set output shafts 304 and 306 could be separately formed and coupled to the angled output gear 318.

Returning once again to FIG. 2, it is seen that each drive mechanism 216 is coupled between the gear set 214 and at least one of the actuators 210. It will be appreciated that the number of drive mechanisms 216 that are included in the system 200 may vary depending, for example, on the number of actuators 210 included in the system 200 and upon the manner in which the gear set 214 is coupled to the actuators 210. For example, in the depicted embodiment the system 200 includes four actuators 210, and the gear set first output shaft 304 is directly connected to one of the first actuators 210. Thus, the depicted system 200 includes three drive mechanisms 216, one first drive mechanism 216-1, and two second drive mechanisms 216-2. The first drive mechanism 216-1 is connected between the second gear set output shaft 306 and one of the second actuators 210. One of the second drive mechanisms 216-2 interconnects the first actuators 210, and the other second drive mechanism 216-2 interconnects the second actuators 210. In an alternative embodiment, the system 200 may include an additional first drive mechanism 216-1 to connect the gear set first output shaft 304 to one of the first actuators 210, rather than making this connection directly. Moreover, in other embodiments that include more than four actuators 210, additional second drive mechanisms 216-2 may be included.

No matter the specific number of drive mechanisms 216 that are included, each is preferably implemented using a flexible shaft or cable. Using flexible shafts 216 in this configuration ensures that the actuators 210 and the transcowls 102 and 104, when unlocked, move in a substantially synchronized manner. For example, when one transcowl 102 is moved, the other transcowl 104 is moved a like distance at substantially the same time. Other synchronization mechanisms that may be used include electrical synchronization or open loop synchronization, or any other mechanism or design that transfers power between the actuators 210. In the depicted arrangement, the rotation of the PDU 212 results in the synchronous operation of the actuators 210, via the gear set 214 and flexible shafts 216, thereby causing the transcowls 102 and 104 to move at substantially the same rate.

The thrust reverser actuation system 200 also preferably includes a PDU brake 222 and a control circuit 224. The PDU brake 222 is configured to selectively prevent or allow rotation of the PDU 212, and thereby selectively prevent or allow transcowl 102, 104 movement. The PDU brake 222 is preferably an electrically controlled device that is responsive to brake commands that are preferably supplied from the control circuit 224 to selectively prevent or allow rotation of the PDU 212. It will be appreciated that the thrust reverser control system 200 may, in some embodiments, include a plurality of additional locks that, together with the PDU brake 222, function to prevent unintended movement of the transcowls 102 and 104 from the stowed position, even in the event of one or more component failures.

The control circuit 224 controls the PDU 212 and, as noted above, the PDU brake 222. The control circuit 224 receives commands from a non-illustrated engine control system such as, for example, a FADEC (full authority digital engine control) system, and receives various signals from one or more positions sensors. In response to these signals, the control circuit 224 supplies appropriate activation signals to the PDU 212 and the PDU brake 222. In turn, the PDU 212 supplies the drive torque to the actuators 210 via the gear set 214 and flexible shafts 216. As a result, the actuators 210 cause the transcowls 102 and 104 to translate between the stowed and deployed positions.

The thrust reverser actuation system 200 described herein is relatively lighter, uses less components, and is relatively less costly than presently known thrust reverser actuation systems.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A thrust reverser actuation system, comprising:
plurality of actuators, each actuator coupled to receive an actuator input torque and configured, upon receipt of the actuator input torque, to move between a stowed position and a deployed position;
a power drive unit having only one output shaft, the power drive unit configured to supply a drive torque via the output shaft; and
a gear set connected to the output shaft and coupled to each of the actuators, the gear set configured to receive the drive torque via the output shaft and supply the actuator input torque to each of the actuators.

2. The system of claim 1, further comprising:
a plurality of drive mechanisms, each drive mechanism coupled between the gear set and at least one of the plurality of actuators.

3. The system of claim 2, wherein each drive mechanism comprises a flexible shaft.

4. The system of claim 1, wherein the gear set comprises a right angle, speed-reducing gear set, having a first output shaft and a second output shaft.

5. The system of claim 4, wherein the first output shaft of the gear set is directly connected to one of the plurality of actuators.

6. The system of claim 5, further comprising:
a first drive mechanism connected between the second output shaft of the gear set and one of the actuators; and
a plurality of second drive mechanisms, each second drive mechanism connected between two of the actuators.

7. The system of claim 6, wherein each drive mechanism comprises a flexible shaft.

8. The system of claim 1, wherein the power drive unit comprises an electric motor.

9. The system of claim 8, further comprising a power drive unit brake coupled to the electric motor.

10. A thrust reverser actuation system, comprising:
a plurality of actuators, each actuator coupled to receive an actuator input torque and configured, upon receipt of the actuator input torque, to move between a stowed position and a deployed position;
an electric motor having only one output shaft, the electric motor adapted to be selectively energized and configured, upon being energized, to supply a motor drive torque via the output shaft; and
a right angle, speed-reducing gear set, the gear set having a gear set input shaft, a first gear set output shaft, and a second gear set output shaft, the gear set input shaft connected to the motor output shaft to receive the motor drive torque, the first gear set output shaft and the second gear set output shaft each coupled to at least two of the actuators to supply the actuator input torque thereto.

11. The system of claim 10, wherein the first gear set output shaft is directly connected to one of the actuators.

12. The system of claim 11, further comprising:
a first drive mechanism connected between the second gear set output shaft and one of the actuators; and
a plurality of second drive mechanisms, each second drive mechanism connected between two of the actuators.

13. The system of claim 12, wherein each drive mechanism comprises a flexible shaft.

14. The system of claim 10, further comprising an electric brake coupled to the electric motor.

15. A thrust reverser actuation system, comprising:
a first moveable thrust reverser component configured to move between a stowed position and a deployed position;
a second moveable thrust reverser component configured to move between a stowed position and a deployed position;
plurality of first actuators, each first actuator coupled the first moveable thrust reverser component, each first actuator further coupled to receive an actuator input torque and configured, upon receipt of the actuator input torque, to move between a stowed position and a deployed position, to thereby move the first moveable thrust reverser component between its stowed position and deployed position, respectively;
plurality of second actuators, each second actuator coupled the second moveable thrust reverser component, each second actuator further coupled to receive an actuator input torque and configured, upon receipt of the actuator input torque, to move between a stowed position and a deployed position, to thereby move the second moveable thrust reverser component between its stowed position and deployed position, respectively;
an electric motor having only one output shaft, the electric motor adapted to be selectively energized and configured, upon being energized, to supply a motor drive torque via the output shaft; and
a gear set connected to the output shaft and coupled to each of the first actuators and to each of the second actuators, the gear set configured to receive the drive torque via the output shaft and supply the actuator input torque to the first actuators and the second actuators.

16. The system of claim 15, wherein the gear set comprises a right angle, speed-reducing gear set, having a first gear set output shaft and a second gear set output shaft.

17. The system of claim 16, wherein the first gear set output shaft is directly connected to one of the first actuators.

18. The system of claim 17, further comprising:
a first drive mechanism connected between the second gear set output shaft and one of the second actuators; and
a plurality of second drive mechanisms, at least one second drive mechanism connected between two of the first actuators, and at least one second drive mechanism connected between two of the second actuators.

19. The system of claim 18, wherein each drive mechanism comprises a flexible shaft.

20. The system of claim 15, further comprising an electric brake coupled to the electric motor.
